(19) United States
(12) Patent Application Publication
(10) Pub. No.: US 2026/0011033 A1
(43) Pub. Date: Jan. 8, 2026

(54) METHOD AND CALIBRATION SYSTEM FOR CALIBRATING A VEHICLE CAMERA

(71) Applicant: Robert Bosch GmbH, Stuttgart (DE)

(72) Inventors: Bence ERDEI, Vecses (HU); Reiner Leikert, Munich (DE)

(21) Appl. No.: 19/263,308

(22) Filed: Jul. 8, 2025

(30) Foreign Application Priority Data
May 17, 2024 (DE) 10 2024 204 612.4

(51) Int. Cl. G06T 7/80; G06T 7/73

(52) U.S. Cl. CPC G06T 7/80; G06T 7/74

(57) ABSTRACT

Calibration of a vehicle camera. A method for the calibration includes: capturing the vehicle using first, second, and third calibration cameras; ascertaining a spatial position of the vehicle in relation to a reference coordinate system in calibration images generated by the calibration cameras; capturing a reference for a projector arranged in the environment of the vehicle by at least one of the calibration cameras; ascertaining a spatial position of the projector in relation to the reference coordinate system based on the captured reference for the projector; projecting a predefined calibration pattern into a capture region of the vehicle camera using the projector; capturing the calibration pattern using the vehicle camera; ascertaining deviations of the calibration pattern captured by the vehicle camera from an expected calibration pattern in an image generated by the vehicle camera; and using calibration information that represents the ascertained deviations for calibrating the vehicle camera.

### FIELD

The present invention relates to a method and a calibration system for calibrating a vehicle camera.

### BACKGROUND INFORMATION

From the related art, cameras arranged on vehicles (hereinafter also referred to as vehicle cameras) are used for capturing the environment in order to make possible, on the basis of image data from the vehicle cameras, for example driver assistance functions such as parking aids and/or (partially) automated driving operation of the vehicles.

Here, in order to achieve the highest possible accuracy in capturing objects in the environment of the vehicle, intrinsic and/or extrinsic calibrations of the vehicle cameras are usually required. Intrinsic calibration relates to the imaging accuracy of an environment captured by the vehicle cameras on a 2D sensor of the vehicle cameras, so that, on the basis of the intrinsic calibration, for example pincushion distortions of the optics of the vehicle cameras can be compensated for.

Extrinsic calibration, on the other hand, relates to the arrangement and alignment accuracy of the vehicle cameras on the vehicles, which can deviate from a target state, for example, due to the installation of the vehicle cameras and/or the operation of the vehicles.

Such intrinsic and/or extrinsic calibrations of vehicle cameras are usually performed in the related art on the basis of predefined markings on the ground and/or on objects (e.g., a wall) in a calibration environment by placing the vehicles at a predefined target position and with a predefined target orientation in relation to the markings.

On the basis of images generated by the vehicle cameras, it is then possible to identify the markings contained in the images and compare their positions and characteristics with a target specification. In a case where deviations from the target specification are ascertained which lie outside a predefined tolerance for the target specification, items of information with respect to the deviations can be used to at least partially compensate for the deviations, for example on the basis of a calculation by means of a computer program, in order to thereby achieve a calibrated state of the cameras.

### SUMMARY

According to a first aspect of the present invention, a method for calibrating a vehicle camera is provided, wherein the camera is, for example, a color and/or a black/white camera and/or a mono camera and/or a stereo camera. A vehicle on which the vehicle camera to be calibrated can be arranged is, for example, a road vehicle such as a car, a truck, a bus, a van, a motorcycle, etc.

Preferably, the vehicle camera is a sensor of an environment capture system of the vehicle, which can, for example, comprise further sensors such as further cameras and/or radar sensors and/or ultrasonic sensors and/or lidar sensors and/or sensors different therefrom. Accordingly, the vehicle camera is preferably arranged and aligned on the vehicle in such a way that it can at least partially capture the environment of the vehicle.

According to an example embodiment, in a first step of the method according to the present invention, the vehicle on which the vehicle camera is arranged is captured by means of at least a first calibration camera, a second calibration camera and a third calibration camera (and optionally by further calibration cameras), wherein the calibration cameras in each case are arranged remotely from the vehicle and each of the calibration cameras is arranged and aligned in such a way that it captures the vehicle at least partially within a field of view of the particular calibration camera. For this purpose, the vehicle is initially placed in a capture region of the calibration cameras and/or the calibration cameras are placed around the vehicle in a suitable manner so that they can capture the vehicle at least partially.

Preferably, the calibration cameras and the components described below which are used in the method according to the present invention are not moved during the execution of the method in order to ensure a fixed spatial relationship in relation to one another that is required for the method.

In a second step of the method according to the present invention, a spatial position of the vehicle in relation to a reference coordinate system is ascertained on the basis of the at least partially captured vehicle in calibration images generated by the calibration cameras.

The spatial position (also referred to as pose or 6D pose) is generally understood to be a position and an orientation (i.e., an alignment) of the vehicle within the reference coordinate system. It should be noted that the spatial positions of further components used in the method according to the present invention described below may refer to a coordinate system that differs from the reference coordinate system (e.g., to a vehicle coordinate system). Should this be the case, this will be indicated below in each individual case.

Calibration images are understood to mean items of image information that represent respective recordings by the calibration cameras and that are provided by the calibration cameras in the form of digital data, for example, but are not limited to this.

The reference coordinate system can, for example, be a predefined coordinate system related to the environment of the vehicle, which is oriented, for example, to objects (e.g., components of a hall in which the calibration is performed) and/or markings in the environment of the vehicle. Alternatively or additionally, it is also possible that the reference coordinate system is oriented toward a particular spatial position of the calibration cameras and/or further components described below that are used in the method according to the present invention.

It should be noted in general that some or all of the processing steps of the method according to the present invention can be performed on the basis of an evaluation unit, which can be designed, for example, as an ASIC, FPGA, processor, digital signal processor, microcontroller, or the like. The evaluation unit is, for example, connected wirelessly and/or via a wired connection to some or all of the components used in the method according to the present invention (such as the calibration cameras, etc.) via information technology. In this way, calibration images generated by the calibration cameras can be transmitted to the evaluation unit, so that the evaluation unit can ascertain the spatial position of the vehicle in relation to the reference coordinate system on the basis of the calibration images.

The ascertainment is carried out for example on the basis of a conventional algorithm from the related art (which is implemented for example in the form of a computer program), which is carried out by the evaluation unit. The spatial position of the vehicle is ascertained, for example, by the algorithm identifying components of the vehicle and/or aids mounted on the vehicle in a predefined manner and comparing them, for example, with a predefined 3D model of the vehicle, in order to ascertain their position on the vehicle in order to determine the spatial position of the vehicle in relation to the reference coordinate system on this basis.

The spatial position of the vehicle in relation to the reference coordinate system can furthermore be advantageously ascertained by using a conventional vehicle coordinate system from the related art for the vehicle, in order to establish a relationship between the reference coordinate system and the vehicle coordinate system. In the case of using a 3D model of the vehicle as described above, the 3D model can be linked accordingly to the vehicle coordinate system.

Furthermore, it is possible that the processing of the present method is carried out on the basis of a large number of evaluation units in a distributed system. In addition, it is possible that the evaluation unit is a separate unit (e.g., a computer) and/or is part of one or more components used in the method according to the present invention (e.g., one or more calibration cameras, etc.).

Such a vehicle coordinate system is often defined as a Cartesian coordinate system, in which an x-axis represents a longitudinal direction, a y-axis a transverse direction and a z-axis a vertical axis of the vehicle. For example, the origin of the vehicle coordinate system can be at the center of gravity of the vehicle. It is understood that both the assignment of the respective axes and the position of the origin can be defined differently.

In a third step of the method according to the present invention, a reference for a projector arranged in the environment of the vehicle is captured by at least one of the calibration cameras. In other words, the calibration cameras and the projector are arranged and aligned with one another in such a way that the reference for the projector lies in a field of view of at least one of the calibration cameras. The reference for the projector can be any part of the projector and/or an object firmly connected to the projector and/or a support such as a tripod for the projector.

In a fourth step of the method according to the present invention, a spatial position of the projector in relation to the reference coordinate system is ascertained on the basis of the captured reference for the projector. Since a spatial position of the respective calibration cameras can be derived from the first method step, it is accordingly possible to ascertain the spatial position of the projector in relation to the reference coordinate system or in relation to the respective calibration cameras.

In a fifth step of the method according to the present invention, a predefined calibration pattern is projected into a capture region of the vehicle camera by means of the projector. Accordingly, when positioning and aligning the projector, care must be taken to ensure that the projection direction of the projector is set in such a way that the calibration pattern can be at least partially captured by the vehicle camera.

The calibration pattern can, for example, contain one or more geometric figures (e.g., circles, ellipses, lines, polygons such as triangles, rectangles, etc.) or elements deviating from these. In particular, a regular arrangement of a large number of elements (e.g., in a matrix form or the like) can be helpful in order to be able to identify the individual elements more easily and/or to be able to ascertain a perspective distortion of the calibration pattern within the image of the vehicle camera, etc. In addition, it is possible that individual or different elements of the calibration pattern are formed in different colors at least in part.

In a sixth step of the method according to the present invention, the calibration pattern is captured by means of the vehicle camera. Images recorded by the vehicle camera containing the calibration pattern can, for example, be transmitted to the evaluation unit described above for further processing by the evaluation unit.

In a seventh step of the method according to the present invention, deviations of the calibration pattern captured by the vehicle camera from an expected calibration pattern in an image generated by the vehicle camera (preferably by the evaluation unit) are ascertained. This is carried out, for example, in such a way that the respective elements of the calibration pattern are identified based on their spatial position and/or their particular perspective distortion and/or shape and/or color, etc., in order to use the items of information obtained therefrom for comparison with the expected calibration pattern. Depending on the spatial position of the projector in relation to the spatial position of the vehicle, it may also be necessary to perspectively correct the predefined calibration pattern and/or the calibration pattern captured by the vehicle camera in order to be able to compare the expected calibration pattern with the captured calibration pattern. The items of information required for the distortion correction are available, since both the spatial position of the vehicle and the spatial position of the projector or the projection direction of the projector within the reference coordinate system are known by the steps described above.

In an eighth step of the method according to the present invention, calibration information that represents the ascertained deviations is used for calibrating the vehicle camera. For example, the calibration information comprises compensation values that can be transmitted to the vehicle camera and/or a different component of the vehicle (e.g., a driver assistance system and/or a system for (partially) automated driving, etc.) in order to calibrate images captured by the vehicle camera on the basis of these compensation values.

The method according to the present invention offers, among other things, the advantage that a particularly flexible and precise calibration of vehicle cameras is possible, since the vehicle does not initially have to be moved to a predefined calibration position with great effort and since the calibration cameras and the projector can be flexibly arranged around the vehicle in order, for example, to calibrate different vehicle cameras arranged on the vehicle (e.g., rear-view cameras, side cameras, front cameras, etc.).

Since the vehicle and/or calibration elements such as calibration mats, etc., do not have to be positioned precisely, particularly fast calibration of vehicle cameras can be achieved.

Preferred developments of the present invention are disclosed herein.

In an advantageous example embodiment of the present invention, the projector is designed as a laser projector. As a result, among other things, a particularly precise projection of the calibration pattern with a particularly high contrast can be achieved. In addition, it is possible to align the projector automatically and/or manually to project the calibration pattern into the field of view of the vehicle camera. In the case of automatic alignment, the projector and/or a support for the projector such as a tripod, etc., can be equipped with one or more actuators in order to adjust the beam direction of the projector accordingly.

In a further advantageous example embodiment of the present invention, the vehicle is captured in the first method step on the basis of at least four calibration cameras in order to achieve a particularly reliable recognition of the vehicle and/or the calibration cameras among one another and/or the projector. Alternatively or additionally, positioning and/or aligning the respective calibration cameras ensures that each calibration camera captures at least one other calibration camera in its particular field of view, so that the spatial position of the vehicle can additionally be ascertained on the basis of an identification of spatial positions and/or alignments of the calibration cameras.

Particularly preferably, according to an example embodiment of the present invention, the calibration cameras and/or the projector are localizable and/or identifiable by respective target panels, wherein the target panels are each arranged immovably in relation to the calibration cameras and/or the projector. The target panels can, for example, be designed as two-dimensional or three-dimensional target panels, which are preferably provided with predefined target panel patterns (e.g., checkerboard-like patterns, etc.) in order to be able to reliably identify the target panels in the images of the calibration cameras. Particularly preferably, the target panel patterns are designed in such a way that the calibration cameras and/or the projector can be clearly identified based on the target panel patterns.

In a further particularly preferred example embodiment of the present invention, the calibration pattern is pre-distorted depending on a projection direction and a distance of the projector in relation to the vehicle camera, so that the projected calibration pattern matches the expected calibration pattern when captured by the vehicle camera if the vehicle camera is in a calibrated state. On the one hand, this offers the advantage that the calibration of the vehicle camera can be performed within the vehicle itself without the image captured by the vehicle camera having to be transmitted to an external processing unit (e.g., an external computer), since the captured calibration pattern can be directly compared with the expected pattern without having to perform further distortion correction of the captured image. This results in the further advantage that reduced computing power and/or computing time is required when ascertaining deviations between the captured calibration pattern and the expected calibration pattern, which may allow a more cost-effective computing unit/evaluation unit to be used for ascertaining the deviations. A further particular advantage can be achieved by pre-distorting the calibration pattern to be projected by the projector in such a way that any unevenness of a projection surface for the calibration pattern (e.g., a floor surface) can be at least partially compensated for. Such unevenness can be, for example, holes or dents in the projection surface and/or an inclination of the projection surface, etc. Alternatively or additionally, this can be used to compensate for a vehicle inclination that deviates from the target inclination of the vehicle, wherein this deviation can be caused, for example, by uneven tire pressures or the like.

Advantageously, according to an example embodiment of the present invention, intrinsic parameters of the vehicle camera and/or extrinsic parameters of the vehicle camera are calibrated on the basis of the calibration information. Intrinsic parameters relating to an intrinsic calibration of the vehicle camera comprise, for example, a pincushion distortion due to an influence of lenses, while extrinsic parameters concerning an extrinsic calibration of the vehicle camera comprise, for example, an arrangement position and an alignment of the vehicle camera on the vehicle.

In a further example embodiment of the present invention, the calibration pattern is projected onto a floor surface in the environment of the vehicle and/or onto an object in the environment of the vehicle, in particular onto a panel and/or a wall and/or a screen.

Further preferably, according to an example embodiment of the present invention, the spatial position of the vehicle is ascertained on the basis of at least one target panel arranged on a vehicle wheel in order to ascertain a spatial position of a vehicle axle connected to the vehicle wheel on the basis of the target panel. The spatial position of the vehicle axle (in particular a non-steerable axle) can then advantageously be used as a basis for determining the vehicle coordinate system and/or generally as a reference object for ascertaining the spatial position of the vehicle camera.

In a further advantageous embodiment of the present invention, the calibration pattern is a moving pattern that is projected at least partially circumferentially around the vehicle. This offers the advantage that, on the one hand, a dynamic behavior of the vehicle camera can be checked and, on the other hand, that, on the basis of a single projector, a large number of vehicle cameras, which can in principle be arranged at any position on the vehicle, can be calibrated on the basis of the moving calibration pattern.

Advantageously, according to an example embodiment of the present invention, at least some of the calibration cameras and/or the projector are placed as mobile devices in the region of the vehicle, wherein particularly advantageously all of these devices can be designed as mobile devices. Alternatively or additionally, these devices are at least in part arranged stationarily in the region of the vehicle. For example, the projector can advantageously be arranged above the vehicle on a hall ceiling, etc., which can result in particularly high flexibility when projecting the calibration pattern.

Particularly preferably, the spatial position of the vehicle in relation to the reference coordinate system and/or the expected spatial position of the vehicle camera on the vehicle are ascertained on the basis of data that represent a 3D model of the vehicle. This 3D model of the vehicle can, for example, be stored in a memory unit that can be connected via information technology to the evaluation unit described above, so that the evaluation unit can retrieve data describing the 3D model from the memory unit and use these data.

According to a second aspect of the present invention, a calibration system for calibrating a vehicle camera is provided. According to an example embodiment of the present invention, the calibration system comprises: at least a first calibration camera, a second calibration camera, a third calibration camera, a projector and an evaluation unit, wherein the first calibration camera, the second calibration camera and the third calibration camera are configured to capture a vehicle on which the vehicle camera is arranged, wherein the calibration cameras are each arranged remotely from the vehicle and wherein each of the calibration cameras is configured to capture the vehicle at least partially. The evaluation unit is configured to ascertain a spatial position of the vehicle in relation to a reference coordinate system on the basis of the at least partially captured vehicle in calibration images generated by the calibration cameras. At least one of the calibration cameras is configured to capture a reference for the projector located in the environment of the vehicle. The evaluation unit is further configured to ascertain a spatial position of the projector in relation to the reference coordinate system on the basis of the captured reference for the projector. The projector is configured to project a predefined calibration pattern into a capture region of the vehicle camera by means of the projector. Finally, the evaluation unit is configured to receive an image of the calibration pattern generated by the vehicle camera, to ascertain deviations of the calibration pattern captured by the vehicle camera from an expected calibration pattern in the image generated by the vehicle camera and to use calibration information that represents the ascertained deviations for calibrating the vehicle camera. The features, combinations of features and the advantages resulting therefrom correspond to those discussed in connection with the first-mentioned aspect of the present invention, such that reference is made to the above statements in order to avoid repetitions.

### BRIEF DESCRIPTION OF THE DRAWING

An exemplary embodiment of the present invention is described in detail below with reference to the figure.

FIG. 1 is a schematic view of an exemplary embodiment of a calibration system according to the present invention.

### DETAILED DESCRIPTION OF EXAMPLE EMBODIMENTS

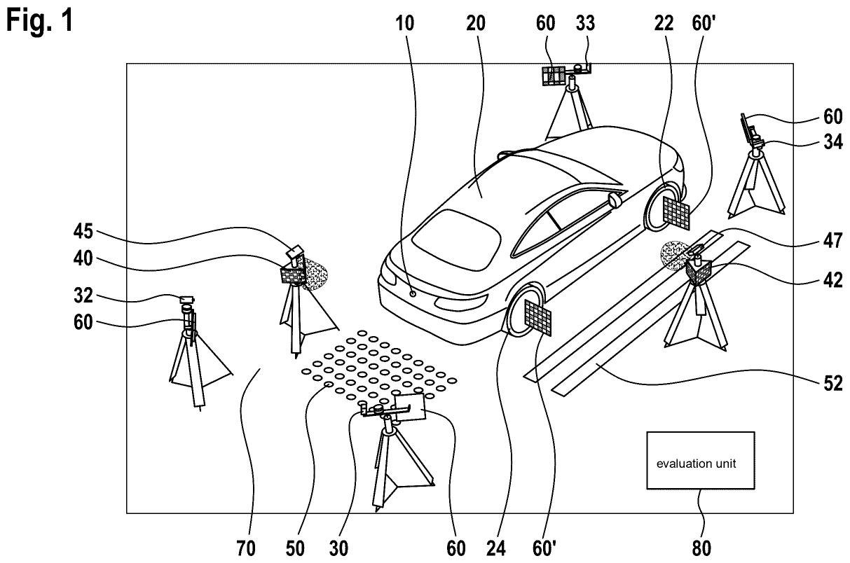

FIG. 1 is a schematic view of an exemplary embodiment of a calibration system according to the present invention for calibrating a vehicle camera 10 of a vehicle 20, which is designed here as a rear-view camera, wherein the calibration system is configured to carry out a method according to the present invention for calibrating the vehicle camera 10, which method is implemented, for example, in the form of a computer program.

The calibration system comprises a first calibration camera 30, a second calibration camera 32, a third calibration camera 33 and a fourth calibration camera 34, a first projector 45, a second projector 47 and an evaluation unit 80.

Here, calibration cameras 30, 32, 33, 34 are each designed as high-resolution RGB cameras, while the projector 45 and the second projector 47 are each designed as laser projectors. Both the calibration cameras 30, 32, 33, 34 and the projector are designed as mobile devices that are mounted on respective tripods.

For each of the calibration cameras 30, 32, 33, 34, a target panel 60 is provided, which in each case is arranged immovably in the region of the calibration cameras 30, 32, 33, 34 in relation to the calibration cameras 30, 32, 33, 34. The target panels 60 in each case comprise different patterns on the basis of which the respective calibration cameras 30, 32, 33, 34 can be clearly identified and localized.

The first projector 45 comprises a first reference 40, while the second projector 47 comprises a second reference 42, which references are each arranged immovably in relation to the projectors 45, 47 in the region of the projectors 45, 47. The first reference 40 and the second reference 42 each comprise different patterns on the basis of which the projectors 45, 47 can be clearly distinguished from one another.

Target panels 60′ for vehicle wheels 22, 24 are arranged on the vehicle 20, which also comprise clearly distinguishable patterns and which are arranged on vehicle wheels 22, 24 in extension of respective vehicle axles.

The evaluation unit 80 is designed here as a personal computer that is arranged remotely from the vehicle 10 and that is configured to exchange items of information wirelessly with the calibration cameras 30, 32, 33, 34, the projectors 45, 47 and the vehicle camera 10.

The first calibration camera 30, the second calibration camera 32, the third calibration camera 33 and the fourth calibration camera 34 are configured to capture the vehicle 20 on which the vehicle camera 10 is arranged, wherein each of the calibration cameras 30, 32, 33, 34 is configured to capture the vehicle 20 at least partially.

The evaluation unit 80 is configured to ascertain a spatial position of the vehicle 20 in relation to a reference coordinate system on the basis of the at least partially captured vehicle 20 in calibration images generated by the calibration cameras 30, 32, 33, 34. For this purpose, the evaluation unit 80 is configured to evaluate the target panels 60′ for the vehicle wheels 22, 24 in order to ascertain a spatial position of the respective vehicle axles on the basis thereof. On the basis of the spatial position of the vehicle axes, a 3D model of the vehicle 20 can be located particularly precisely within the reference coordinate system, so that the calibration accuracy of the vehicle camera 10 is improved.

All calibration cameras 30, 32, 33, 34 are configured to capture the references 40, 42 for the projectors 45, 47 arranged in the environment of the vehicle 20, the other calibration cameras 30, 32, 33, 34 and the respective target panels 60′ for the vehicle wheels 22, 24.

The evaluation unit 80 is further configured to ascertain a spatial position of the projectors 45, 47 in relation to the reference coordinate system on the basis of the captured references 40, 42 for the projectors 45, 47.

The first projector 45 is configured to project a first predefined calibration pattern 50 into a capture region of the vehicle camera 10, while the second projector 47 is configured to project a second predefined calibration pattern 52 into a capture region of a side camera (not shown) of the vehicle 20. Here, the calibration patterns 50, 52 in each case are projected onto a floor surface 70 surrounding the vehicle 20.

The evaluation unit 80 is further configured to receive an image of the first calibration pattern 50 generated by the vehicle camera 10 and an image of the second calibration pattern generated by the side camera, to ascertain deviations of the calibration patterns 50, 52 captured by the vehicle camera 10 and the side camera from respectively expected calibration patterns, and to use respective calibration information that represents the ascertained deviations for calibrating the vehicle camera 10 and the side camera.

1-12. (canceled)

13. A method for calibrating a vehicle camera, comprising the following steps:
capturing a vehicle on which the vehicle camera is arranged using at least a first calibration camera, a second calibration camera, and a third calibration camera, wherein:
the first, second, and third calibration cameras are each arranged remotely from the vehicle, and
each of the first, second, and third calibration cameras captures the vehicle at least partially;
ascertaining a spatial position of the vehicle in relation to a reference coordinate system based on the at least partially captured vehicle in calibration images generated by the first, second, and third, calibration cameras;
capturing a reference for a projector arranged in an environment of the vehicle by at least one of the first, second, and third calibration cameras;
ascertaining a spatial position of the projector in relation to the reference coordinate system based on the captured reference for the projector;
projecting a predefined calibration pattern into a capture region of the vehicle camera using the projector;
capturing the calibration pattern using the vehicle camera;
ascertaining deviations of the calibration pattern captured by the vehicle camera from an expected calibration pattern in an image generated by the vehicle camera; and
using calibration information that represents the ascertained deviations for calibrating the vehicle camera.

14. The method according to claim 13, wherein the projector:
is a laser projector, and/or
is automatically and/or manually aligned to project the calibration pattern into a field of view of the vehicle camera.

15. The method according to claim 13, wherein:
the vehicle is captured in the capturing the vehicle step based on at least four calibration cameras, and/or
by positioning and/or aligning the first, second, and third calibration cameras, it is ensured that each of the first, second, and third calibration cameras captures at least one further calibration camera in its field of view, so that the spatial position of the vehicle can additionally be ascertained based on an identification of positions and/or alignments of the calibration cameras.

16. The method according to claim 13, wherein: (i) the first, second, and third calibration cameras and/or (ii) the projector, are localizable and/or identifiable by respective target panels, which are each arranged immovably in relation to: (i) the first, and, and third calibration cameras and/or (ii) the projector.

17. The method according to claim 13, wherein the calibration pattern is pre-distorted depending on a projection direction and a distance of the projector in relation to the vehicle camera, so that the projected calibration pattern matches a predefined reference pattern when captured by the vehicle camera when the vehicle camera is in a calibrated state.

18. The method according to claim 13, wherein intrinsic parameters and/or extrinsic parameters of the vehicle camera are calibrated based on the calibration information.

19. The method according to claim 13, wherein the calibration pattern is projected onto:
a floor surface in the environment of the vehicle, and/or
an object in the environment of the vehicle, including a panel and/or a wall and/or a screen.

20. The method according to claim 13, wherein the spatial position of the vehicle is ascertained based on at least one target panel arranged on at least one vehicle wheel to ascertain a spatial position of a vehicle axle connected to the vehicle wheel based on the at least one target panel.

21. The method according to claim 13, wherein the calibration pattern is a moving pattern that is projected at least partly circumferentially around the vehicle.

22. The method according to claim 13, wherein: (i) at least some of the first, second, and third calibration cameras and/or (ii) the projector, are placed as mobile devices in a region of the vehicle and/or are at least in part arranged stationarily in the region of the vehicle.

23. The method according to claim 13, wherein the spatial position of the vehicle in relation to the reference coordinate system and/or an expected spatial position of the vehicle camera on the vehicle, are ascertained based on data that represent a 3D model of the vehicle.

24. A calibration system for calibrating a vehicle camera, comprising:
at least a first calibration camera, a second calibration camera, and a third calibration camera;
a projector; and
an evaluation unit;
wherein:
the first calibration camera, the second calibration camera, and the third calibration camera are configured to capture a vehicle on which the vehicle camera is arranged, wherein:
the first, second, and third calibration cameras are each arranged remotely from the vehicle, and
each of the first, second, and third calibration cameras is configured to capture the vehicle at least partially,
the evaluation unit is configured to ascertain a spatial position of the vehicle in relation to a reference coordinate system based on the at least partially captured vehicle in calibration images generated by the first, second, and third calibration cameras,
at least one of the first, second, and third calibration cameras is configured to capture a reference for the projector arranged in an environment of the vehicle,
the evaluation unit is configured to ascertain a spatial position of the projector in relation to a reference coordinate system based on the captured reference for the projector,
the projector is configured to project a predefined calibration pattern into a capture region of the vehicle camera using the projector, and
the evaluation unit is configured to:
receive an image of the calibration pattern generated by the vehicle camera,
ascertain deviations of the calibration pattern captured by the vehicle camera from an expected calibration pattern in the image generated by the vehicle camera, and
use calibration information that represents the ascertained deviations for calibrating the vehicle camera.
